(19) United States
(12) Patent Application Publication
(10) Pub. No.: US 2023/0065991 A1
(43) Pub. Date: Mar. 2, 2023

(54) ELECTROMAGNETIC COMPATIBILITY FILTER OF A WIND POWER INSTALLATION

(71) Applicant: Wobben Properties GmbH, Aurich (DE)

(72) Inventors: Juri Wilhelm, Aurich (DE); Sonja Schulz, Aurich (DE)

(21) Appl. No.: 17/899,820

(22) Filed: Aug. 31, 2022

(30) Foreign Application Priority Data
Aug. 31, 2021 (EP) 21194135.6

(51) Int. Cl. H02M 1/12; H02J 3/38; H02M 7/537; H02M 1/44

(52) U.S. Cl. CPC H02M 1/126; H02J 3/381; H02M 7/537; H02M 1/44; H02M 1/123; H02J 2300/28; H01F 27/24

(57) ABSTRACT

Provided is a filter arrangement for a converter module, in particular for a power converter module of a wind power installation, comprising: a magnetic core, which is ring-shaped or tubular, with an opening, and is made of at least one ferro- or ferrimagnetic material, wherein the magnetic core is configured to receive at least a first phase of the converter module and a first conductor of a DC voltage for the converter module through the opening in such a way that the magnetic core forms a choke for the converter module and a choke for the DC voltage.

### BACKGROUND

### Technical Field

The present invention relates to a filter arrangement for a converter module, in particular for a converter of a wind power installation. The present invention further relates to such a converter module and to a converter arrangement, having a plurality of such converter modules, of a wind power installation and to such a wind power installation.

### Description of the Related Art

Converters, also referred to as AC converters, are power converters, which take a DC or AC voltage and generate a new AC voltage of a different frequency and amplitude.

In order to ensure a certain quality in the currents generated by the converter, further electrical components or circuits, such as filters, for example, which have a current-compensating choke, are usually arranged at the output of the converters.

However, known filters of this type, i.e., filters with a current-compensating choke, have only a limited area of application.

Furthermore, converters are often connected in parallel with a higher-power converter arrangement, for example in the field of wind power installations.

The converter arrangement then comprises a plurality of individual converters, which are also referred to as converter modules and are functionally connected to each another.

However, this parallel connection of converters or converter modules to form such a converter arrangement often leads to so-called circulating or ring currents within the converter arrangement, which can drive the current-compensating chokes of the individual converters or converter modules into saturation.

### BRIEF SUMMARY

Provided is an improved filter for converters or converter modules and/or converter arrangements of wind power installations.

Provided is a converter module, comprising a magnetic core, which is ring-shaped or tubular, with an opening, and is made of at least one ferro- or ferrimagnetic material, wherein the magnetic core is configured to receive at least a first phase of the converter module and a first conductor of a DC voltage for the converter module through the opening in such a way that the magnetic core forms a choke for the converter module and a choke for the DC voltage.

In particular, a filter arrangement for a converter module is thus proposed which has both the functionality of a grid choke and the functionality of a common mode choke. For this purpose, all of the conductors and phases that are relevant to the converter module are preferably routed through the opening in the magnetic core.

For this purpose, the filter arrangement has, in particular precisely, one magnetic core, which is formed, for example, from a combination of cores.

The magnetic core is preferably ring-shaped or tubular and made of a ferro- or ferrimagnetic material, such as, for example, a ferrimagnetic ceramic material. The magnetic core is preferably made of ferrites, in particular soft magnetic ferrites, such as, for example, nickel-zinc or manganese-zinc.

The ring-shaped or tubular form of the magnetic core means that the magnetic core has at least one opening, through which the corresponding phases and/or conductors can be routed, in particular without contact. The phases and/or conductors are preferably not in contact with the magnetic core in this arrangement. The magnetic core is thus in particular unwound/not wound.

At least a first phase of the converter module and a first conductor of a DC voltage for the converter module are routed through the opening formed through the magnetic core. Two DC voltage conductors and three AC voltage phases are preferably routed through the opening. Both an AC voltage and a DC voltage are thus routed through the opening in the magnetic core.

Thus, the opening is such that at least one phase of a converter module and one conductor of a DC voltage can be routed through.

Furthermore, the magnetic core is embodied in such a way that the magnetic core forms, with the at least one phase, a choke for the converter module and, with the at least one conductor, a choke for the DC voltage.

The choke with the phase/phases preferably forms a choke for grid applications or a choke on the grid side or a grid choke.

The choke with the conductor/conductors preferably forms a current-compensating choke or common mode choke.

The filter arrangement described herein thus comprises a magnetic core, which is used simultaneously for a choke for grid applications and for a common mode choke.

Such a filter arrangement is particularly advantageous for a plurality of parallel converter modules, in which ring or circulating currents can occur due to the parallel connection.

The filter arrangement described herein leads in particular to compensation for the circulating currents within the parallel converter modules or the parallel converters and, apropos of that, to significantly later saturation of magnetic cores of the filters at the output of the converters or converter modules.

The magnetic core is preferably configured to receive a first phase, a second phase and a third phase of the converter module and a first conductor and a second conductor of the DC voltage for the converter module through the opening in such a way that the magnetic core forms a choke for the converter module and a choke for the DC voltage.

In particular, it is thus proposed that all three phases of the converter module and the two conductors of the DC voltage, to which the converter module is connected, be routed through one and the same opening in the magnetic core.

The magnetic core is preferably in the form of a combination of cores, in particular in multiple parts.

The magnetic core thus comprises, for example, one, two, three, four or more ring-shaped magnetic cores, which are arranged magnetically with each another and/or mechanically against each another and/or are arranged with each another to form a combination of cores. The combination of cores is then tubular, for example, i.e., formed from a plurality of rings arranged against each other.

The combination of cores likewise has an opening, through which the phases and conductors can be routed.

The ring-shaped, magnetic cores are preferably also referred to as ring cores. Preferably, the filter arrangement has an inductance of between 1 microhenry (μH) and 1000 μH and/or the magnetic core has a permeability of between 100 H*m⁻¹ and 20 000 H*m⁻¹. Particularly preferably, the inductance of the filter arrangement is between 10 μH and 500 μH.

Particularly preferably, the permeability of the magnetic core is between 700 H*m⁻¹ and 10 000 H*m⁻¹.

The filter arrangement and the magnetic core are therefore preferably optimized for converter arrangements of wind power installations.

The filter arrangement preferably further comprises a capacitance for the first phase, wherein the capacitance is in the form of an interference suppression capacitor and/or is arranged downstream of the magnetic core in the direction of current flow.

The capacitance is thus formed, for example, as an X capacitor or as a Y capacitor. The capacitance can also be formed from a plurality of capacitors, which are connected with each other in series or in parallel.

The capacitance preferably comprises between 10 nanofarad (nF) and 10 microfarad (μF).

The capacitance further preferably comprises between 100 nF and 2 μF.

The filter arrangement preferably further comprises a capacitance for the first conductor, wherein the capacitance is in the form of an interference suppression capacitor and/or is arranged upstream or downstream of the magnetic core in the direction of current flow.

The capacitance is preferably arranged downstream of the magnetic core in the direction of current flow.

The capacitance is thus formed, for example, as an X capacitor or as a Y capacitor. The capacitance can also be formed from a plurality of capacitors, which are connected with each other in series and/or in parallel.

The capacitance preferably comprises between 10 nF and 10 μF.

The capacitance further preferably comprises between 100 nF and 2 μF.

In particular, it is thus also proposed that a common magnetic core but separate capacitances be used for the grid choke and the common mode choke.

The filter arrangement is preferably in the form of an EMC filter and/or is configured to filter out high-frequency interference from an AC current generated by the converter module.

The filter arrangement is thus in particular configured to establish electromagnetic compatibility (EMC for short) for the converter module with respect to an electrical supply grid.

Converter modules, in particular power converter modules in wind power installations, have switching frequencies in the kilohertz (kHz) range, which can usually also be seen in the generated AC current from the converter modules. Such interference is in the kHz or megahertz (MHz) range, for example between 150 kHz and 1 gigahertz (GHz).

Alternatively or additionally, the filter arrangement is also configured to filter out harmonics or harmonic oscillations in the generated AC current in the range of multiples of the grid frequency.

For example, the grid frequency is 50 hertz (Hz). The filter arrangement is then configured to filter frequencies of integer multiples of 50 Hz, i.e., for example, in the region of 50 Hz, 100 Hz, 150 Hz, etc.

The converter module preferably has at least a rated power of 300 kilowatt (kW), preferably of at least 600 kW, and the filter arrangement is designed for this rated power or a current generated from this converter module.

Alternatively or preferably, the converter module is configured to deliver more than 1000 ampere (A), for example 1250 A, preferably at a DC voltage of more than 700 volts (V).

The magnetic core preferably has dimensions which allow it to be arranged in a switchgear cabinet.

The magnetic core thus has, for example, an (outside) diameter of less than 200 millimeter (mm).

The filter arrangement preferably has a support which is configured to mount the magnetic core horizontally in a switchgear cabinet, in particular in such a way that the at least one phase runs perpendicularly to the switchgear cabinet through the opening.

Provided is a converter module of a wind power installation, comprising at least a connection for connecting the converter module to a DC voltage; an inverter module connected to the connection, and a converter output connected to the inverter module, wherein at least one filter arrangement as described above or below is arranged at the converter output.

In particular, the converter module is thus in the form of an inverter.

Furthermore, the inverter is preferably supplied with power from a DC voltage and is connected at its output to a filter arrangement as described above or below.

The converter module is preferably in the form of an inverter module of a direct converter.

In particular, it is thus also proposed that one filter arrangement as described above or below be used for each converter module.

Furthermore, the converter module is preferably arranged in a switchgear cabinet, for example in a stand-alone or modular cabinet with the dimensions 800 mm×2000 mm×600 mm. However, the switchgear cabinet can also be 700 mm×1800 mm×600 mm or 600 mm×2000 mm×600 mm.

The converter module preferably further has at least one converter output, which can be connected to an electrical supply grid, in particular in order to exchange electrical power with the electrical supply grid.

The converter output of the converter module is preferably in 3-phase form. In particular, the converter module thus has, at the converter output, at least three phases, to which an AC current is applied and which can be connected to an electrical supply grid.

Precisely those phases of the converter module are routed through the opening in the filter arrangement as described above or below at the converter output.

Three phases of the inverter module and two conductors of the DC voltage are preferably routed through the opening, in particular in the same sense.

The converter module preferably has at least a rated power of 600 kW.

The converter module is preferably part of a back-to-back or B2B or direct converter, or is in the form of such.

The converter module is preferably housed in a switchgear cabinet.

A switchgear cabinet is understood herein to mean, in particular, cabinets which house electrical and electronic components of a process-engineering installation, in particular of a wind power installation. These cabinets are preferably made of painted or powder-coated sheet steel or the like and are embodied as stand-alone or modular cabinets, in particular with dimensions of between 600 mm and 1200 mm wide, between 1600 and 2200 mm high and between 400 mm and 800 mm deep.

Provided is a converter arrangement for a wind power installation, comprising at least a plurality of converter modules as described above or below, wherein the plurality of converter modules are connected in parallel with each other, in particular such that the converter arrangement has a higher rated power than one converter module or one rated power, substantially corresponding to the sum of the rated powers of the converter modules.

The converter arrangement is preferably in the form of a power converter of a wind power installation, i.e., all of the power generated by the generator of the wind power installation is routed via this converter arrangement.

The converter arrangement is thus preferably connected to the generator of the wind power installation and to an electrical supply grid and comprises a plurality of converter modules as described above or below, which are connected in parallel with each other.

In particular, the filter arrangement as described above or below is particularly insensitive to ring currents of such a converter arrangement. In particular, the filter arrangements as described above or below cannot be driven into saturation by any ring currents of such a converter arrangement.

A wind power installation having a converter arrangement as described above or below is furthermore proposed.

The wind power installation is preferably configured to be connected to a wind farm grid or to an electrical supply grid, in particular via a transformer.

In particular, the converter arrangement furthermore has a plurality of converter modules as described above or below, which are connected in parallel with each other.

The converter arrangement is further preferably in the form of a power converter.

### BRIEF DESCRIPTION OF THE SEVERAL VIEWS OF THE DRAWINGS

The present invention will now be explained in more detail below on the basis of the accompanying figures, wherein the same reference signs are used for identical or similar components or assemblies.

FIG. 1 shows schematically and by way of example a perspective view of a wind power installation in one embodiment.

FIG. 2 shows schematically and by way of example an electrical section of a wind power installation in one embodiment.

FIG. 3 shows schematically and by way of example a converter arrangement.

FIG. 4 shows schematically and by way of example a filter arrangement.

FIG. 5 shows schematically and by way of example a filter arrangement in a lower region of a switchgear cabinet.

FIG. 6 shows schematically and by way of example a converter arrangement.

### DETAILED DESCRIPTION

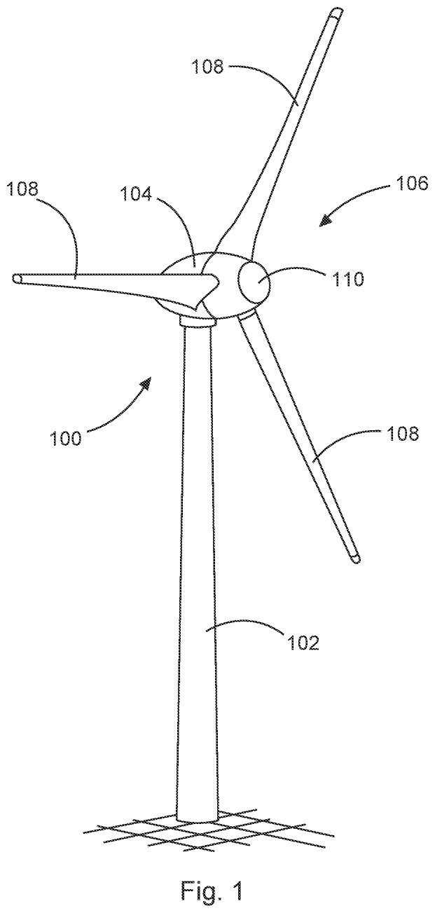

FIG. 1 shows a perspective view of a wind power installation 100.

In this respect, the wind power installation 100 has a tower 102 and a nacelle 104. An aerodynamic rotor 106 with three rotor blades 108 and a spinner 110 is arranged on the nacelle 104. The rotor 106 is caused to effect a rotational movement by the wind during operation and in so doing drives a generator in the nacelle. As a result, the generator generates a current to be supplied, which is supplied to an electrical supply grid by means of a converter arrangement.

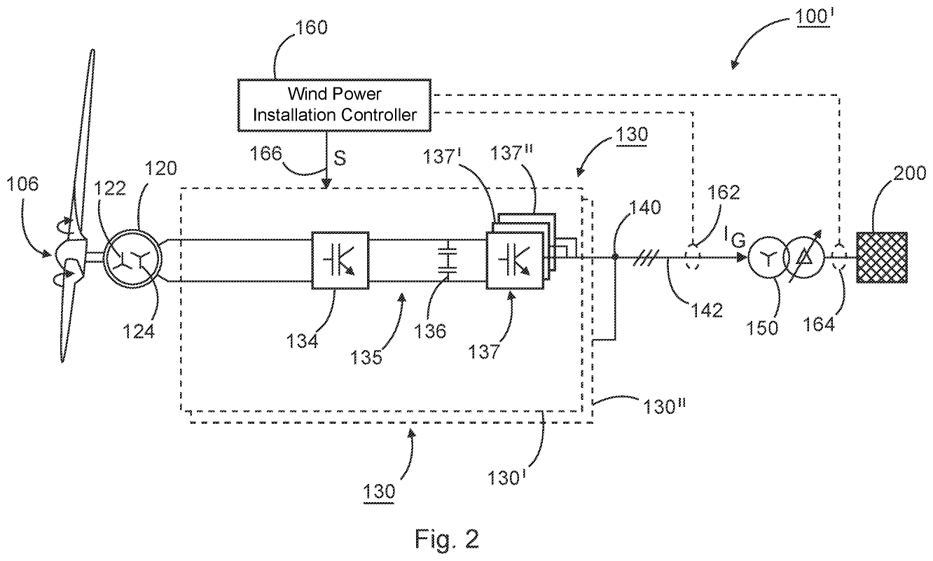

FIG. 2 shows schematically and by way of example an electrical section 100′ of a wind power installation 100, as preferably shown in FIG. 1.

The aerodynamic rotor 106 of the wind power installation is connected to the generator 120 of the wind power installation.

In this case, the generator 120 is preferably in the form of a six-phase generator, for example the generator has two electrically three-phase systems 122, 124 that are decoupled from one another on the stator side.

The generator 120 is further connected to an electrical supply grid 200, or linked to the electrical supply grid 200, via a converter arrangement 130 by means of a transformer 150.

In order to convert the electrical power generated by the generator 120 into a current iG to be supplied, the converter arrangement 130 has a plurality of parallel-connected converter modules 130′, 130″, which are substantially physically identical.

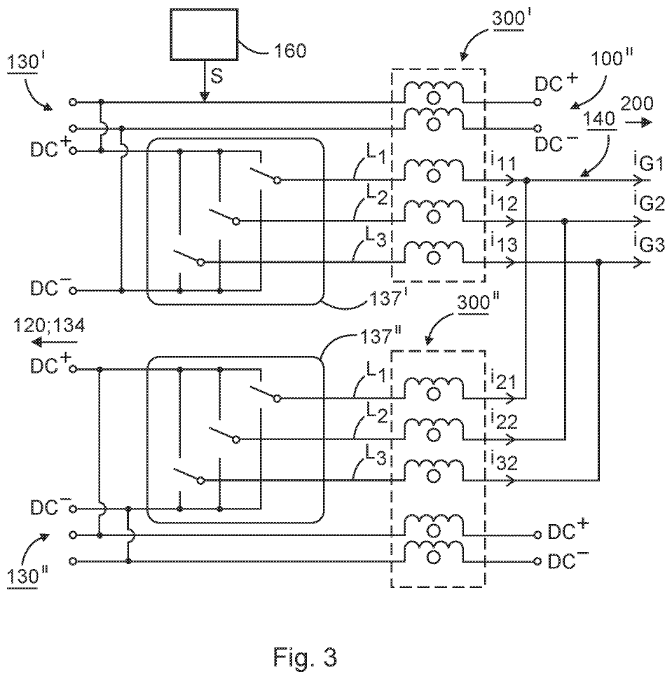

The converter modules 130′, 130″ have an active rectifier 134 at a converter module input. The active rectifier 134 is, for example, connected to a DC link circuit 135, which, for example, has capacitors 136 for the purpose of storage or smoothing. The active rectifier 134 is connected to the inverter 137 via the link circuit 135. In this case, the inverter 137 consists of a plurality of inverter modules 137′, 137″, 137′″, such as shown in FIG. 3, for example, and generates a total current iG to be suppled. In another embodiment, the rectifier 132 can also be of modular design, i.e., it can consist of a plurality of parallel rectifier modules, and/or the converter can be embodied as a back-to-back converter or direct converter, i.e., without a link circuit.

The converter modules 130, 130″ are brought together at a node 140 on the grid side to form a three-phase overall system 142, as shown in FIG. 3, for example.

In order to supply the electrical supply grid 200 with the total current iG to be supplied, the output of the wind power installation further has provision for a wind power installation transformer 150, which is preferably star-delta connected and connects the wind power installation 100 to the electrical supply grid 200.

The electrical supply grid 200, to which the wind power installation 100, 100′ is linked by means of the transformer 150, can be, for example, a wind farm grid or an electrical supply or distribution grid.

A wind power installation control unit (e.g., wind power installation controller) 160 is further provided for controlling the wind power installation 100 or the electrical section 100′.

The wind power installation control unit 160 is configured to detect the total current iG by means of a current detector (e.g., ammeter or multimeter) 162. Preferably, in particular, the currents of each converter module 137′ in each phase are detected for this purpose.

Furthermore, the control unit also has current detector 162.

The control unit 160 is thus in particular configured to control the entire converter 130 with its two converter modules 130′, 130″, in particular as shown in FIG. 3.

FIG. 3 shows schematically and by way of example the design of a converter arrangement 137′, 137″ with a filter arrangement.

The converter arrangement 130′, 130″ is connected to a DC voltage V_DC on the generator side and connected to an electrical supply grid 200 on the grid side.

The converter arrangement 130′, 130″ consists of a first inverter module 137′ and a second inverter module 137″, which are connected in parallel with each another.

Each of the inverter modules 137′, 137″ generates an AC current i11, i12, i13, i21, i22, i23, which is routed to three phases L1, L2, L3 in each case and overlaid at the node 140 to form a three-phase total current ig1, ig2, ig3 to supplied.

The converter arrangement 130′, 130″ is controlled, for example, by means of a wind power installation control unit 160 and switching signals S.

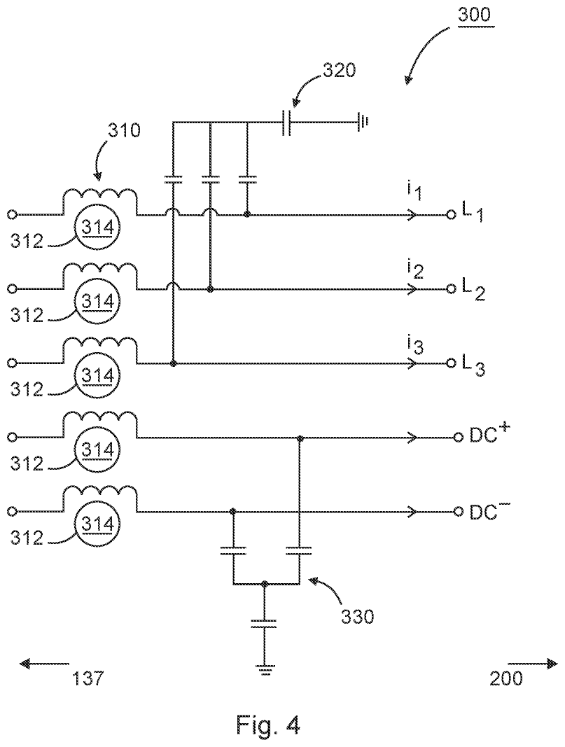

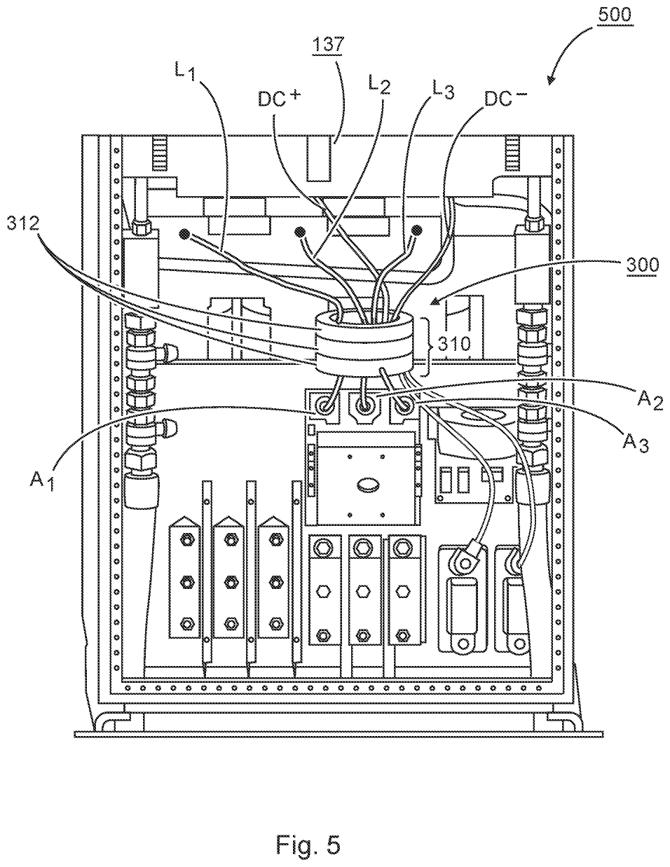

A filter arrangement 300′, 300″ as described above or below is arranged at the output of each of the inverter modules 137′, 137″, which filter arrangements are embodied in particular as described in FIG. 4 and/or FIG. 5.

FIG. 4 shows schematically and by way of example a filter arrangement 300, in particular between an inverter module 137 and an electrical supply grid 200.

The filter arrangement 300 comprises a magnetic core 310, an AC capacitance 320 and a DC voltage capacitance 330.

The magnetic core 310 is embodied as a combination of cores 312 in multiple parts and comprises an opening 314.

The three phases L1, L2, L3 of the inverter module 137 and the two conductors DC+, DC− of a DC voltage for the inverter module 137 are routed through the opening 314, in particular such that the filter arrangement forms both a grid choke and a common mode choke.

An AC capacitance 320 and a DC voltage capacitance 330 are furthermore arranged downstream of the magnetic core 310 in the direction of current flow.

FIG. 5 shows schematically and by way of example a filter arrangement 300 in a lower region of a switchgear cabinet 500.

The converter module 137 is arranged centrally in the switchgear cabinet and has three phases L1, L2, L3, which are connected to an electrical supply grid by means of terminals A1, A2, A3.

The converter module 137 is connected to a DC voltage for the converter module 137, which voltage is routed via two conductors DC+, DC−.

Both the phases L1, L2, L3 and the conductors DC+, DC− are routed through an opening 314 in the magnetic circuit 310.

The magnetic circuit 310 is in the form of a combination of cores made up of three ferrimagnetic rings 312, which are coupled to each other both mechanically and magnetically.

The filter arrangement 300 is therefore arranged, from an electrical point of view, on the grid side, i.e., downstream of the converter module 137 in the direction of current flow.

The DC voltage U_{DC} comes from the link circuit 135, that is to say is arranged, from an electrical point of view, on the generator side, i.e., upstream of the converter module 137 in the direction of current flow.

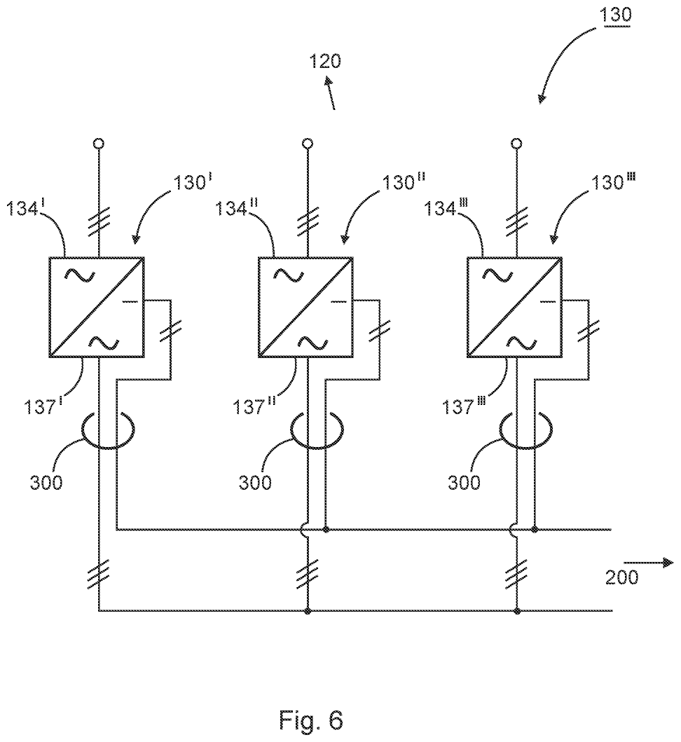

FIG. 6 shows schematically and by way of example a converter arrangement 130.

The converter arrangement 130 is connected to a generator 120 of a wind power installation and to an electrical supply grid 200.

The converter arrangement 130 comprises three converter modules 130′, 130″, 130′″, which are connected in parallel with each other.

The converter modules 130′, 130″, 130′″ are in the form of back-to-back converters and comprise an active rectifier 134′, 134″, 134′″, which is connected to the generator, and an inverter 137′, 137″, 137′″, which is connected to the electrical supply grid, said rectifier and inverter being connected via a DC link circuit.

A filter arrangement 300 as described above or below is arranged at the output of each converter module 130′, 130″, 130′″.

The filter arrangements 300 each have an opening within a magnetic core, through which opening DC voltage of the DC link circuit and the output of the inverter 137′, 137″, 137′″ are routed.

The filter arrangements 300 are in particular embodied as described above or below.

In particular, the filter arrangements 300 are configured to minimize the circulating currents within the converter arrangement 130 and/or to prevent saturation of the ring cores of the filter arrangement.

The filter arrangement proposed herein allows in particular:
compensation for the circulating currents and, apropos of that, significantly later saturation of the ring cores;
an option to use smaller ring cores, which saves space inside the switchgear cabinets;
an option of filtering using ferrite cores, where otherwise nanocrystalline material would be required; and
a lower circulating current load on the rest of the system, in particular on the electrical system of the wind power installation.

### LIST OF REFERENCE SIGNS

100 wind power installation
100′ electrical section, in particular of the wind power installation
100″ detail of the electrical section
102 tower, in particular of the wind power installation
104 nacelle, in particular of the wind power installation
106 rotor, in particular of the wind power installation
108 rotor blade, in particular of the wind power installation
120 generator, in particular of the wind power installation
122 first electrical system, in particular of the generator
124 second electrical system, in particular of the generator
130 converter arrangement, in particular of the wind power installation
130′ converter module, in particular for the first electrical system
130″ converter module, in particular for the second electrical system
134 active rectifier, in particular of the converter module
135 DC link circuit, in particular of the converter module
136 capacitor, in particular of the DC link circuit
137 inverter
137′ inverter module
137″ inverter module
137′″ converter submodule, in particular inverter module
140 node
142 three-phase (overall) system
150 transformer
160 wind power installation control unit
162 current detector
200 electrical supply grid
300 filter arrangement
310 magnetic core
312 combination of cores
312′ ferro- or ferrimagnetic ring, in particular combination of cores
320 AC capacitance
330 DC voltage capacitance
500 switchgear cabinet
L1, L2, L3 phases of a converter module
DC+, DC− conductors of a DC voltage
i_{G} total current to be supplied
U_{DC} DC voltage
u voltage of a phase
i current of a phase
S (switching) signal
1,2,3 indices

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A filter arrangement for a converter module, comprising:
a magnetic core, wherein the magnetic core
is ring-shaped or tubular,
has an opening, and
is made of at least one material selected from ferromagnetic material or ferrimagnetic material, and
wherein the magnetic core is configured to:
receive, through the opening, at least a first phase of the converter module and a first conductor of a DC voltage for the converter module, and
form a choke for the converter module and a choke for the DC voltage.

2. The filter arrangement as claimed in claim 1, wherein the converter module is part of a power converter module of a wind power installation.

3. The filter arrangement as claimed in claim 1, wherein the magnetic core is configured to:
receive, through the opening, a second phase and a third phase of the converter module and a first conductor and a second conductor of the DC voltage for the converter module; and
form a choke for the converter module and a choke for the DC voltage.

4. The filter arrangement as claimed in claim 1, wherein the magnetic core includes a combination of cores.

5. The filter arrangement as claimed in claim 1, wherein the filter arrangement has an inductance of between 1 microhenry (μH) and 1000 μH or the magnetic core has a permeability of between 100 henry/meter (H*m⁻¹) and 20 000 H*m⁻¹.

6. The filter arrangement as claimed in claim 1, comprising:
a capacitance for the first phase, wherein the capacitance is an interference suppression capacitor or the capacitance is arranged downstream of the magnetic core in a direction of current flow.

7. The filter arrangement as claimed in claim 1, comprising:
a capacitance for the first conductor, wherein the capacitance is an interference suppression capacitor or the capacitance is arranged downstream of the magnetic core in a direction of current flow.

8. The filter arrangement as claimed in claim 1, wherein the filter arrangement is an electromagnetic compatibility (EMC) filter or is configured to filter out high-frequency interference from an AC current generated by the converter module.

9. The filter arrangement as claimed in claim 1, wherein the converter module has a rated power of at least 300 kilowatt (kW), and the filter arrangement is configured for the rated power or a current generated from the converter module.

10. The filter arrangement as claimed in claim 9, wherein the converter module has a rated power of at least 600 kW.

11. The filter arrangement as claimed in claim 1, wherein:
the magnetic core is dimensioned to be arranged in a switchgear cabinet; or
the filter arrangement has support that is configured to mount the magnetic core horizontally in a switchgear cabinet.

12. The filter arrangement as claimed in claim 11, wherein the first phase runs perpendicularly through the opening.

13. A converter module, comprising:
a connection for coupling the converter module to a DC voltage;
an inverter module coupled to the connection; and
a converter output coupled to the inverter module, wherein at least one filter arrangement is arranged at the converter output, wherein the at least one filter arrangement includes:
a magnetic core, wherein the magnetic core
is ring-shaped or tubular,
has an opening, and
is made of at least one material selected from ferromagnetic material or ferrimagnetic material, and
wherein the magnetic core is configured to:
receive, through the opening, at least a first phase of the converter module and a first conductor of the DC voltage for the converter module, and
form a choke for the converter module and a choke for the DC voltage.

14. The converter module as claimed in claim 13, wherein three phases of the inverter module and two conductors of the DC voltage are routed through the opening.

15. The converter module as claimed in claim 13, wherein the converter module has a rated power of at least 600 kilowatt (kW).

16. The converter module as claimed in claim 13, wherein the converter module is housed in a switchgear cabinet.

17. A converter arrangement, comprising:
a plurality of converter modules including the converter module as claimed in claim 13, wherein the plurality of converter modules are coupled in parallel with each other.

18. A wind power installation, comprising:
the converter arrangement as claimed in claim 17.
